(19) United States
(12) Patent Application Publication
(10) Pub. No.: US 2024/0187898 A1
(43) Pub. Date: Jun. 6, 2024

(54) CONFIGURATION OF A DEVICE TO AVOID FREQUENCY CONFLICTS

(71) Applicant: Nokia Technologies Oy, Espoo (FI)

(72) Inventors: Faranaz SABOURI-SICHANI, Aalborg (DK); Tero HENTTONEN, Espoo (FI); Srinivasan SELVAGANAPATHY, Bangalore (IN); Aby KANNEATH ABRAHAM, Bangalore (IN)

(21) Appl. No.: 18/553,950

(22) PCT Filed: Apr. 26, 2022
(86) PCT No.: PCT/EP2022/060960

§ 371 Date: Oct. 4, 2023

(30) Foreign Application Priority Data
May 6, 2021 (IN) 202141020657

(51) Int. Cl. H04W 24/08; H04W 24/10

(52) U.S. Cl. CPC H04W 24/08; H04W 24/10

(57) ABSTRACT

Various example embodiments relate to configuration of an apparatus to avoid frequency conflicts between activities associated with different subscriptions. The apparatus may receive, from a first network, a measurement configuration comprising an indication of a plurality of frequencies or cells for performing cell measurements. The apparatus may determine, from the plurality of frequencies or cells, at least one non-preferred frequency or cell at which simultaneous operation of the apparatus at the first network and at least one second network is restricted, and transmit, to the first network, an indication of the at least one non-preferred frequency or cell. The first network may be reconfigured to deprioritize use of the at least one non-preferred frequency or cell for the apparatus. Apparatuses, methods, and computer programs are disclosed.

### TECHNICAL FIELD

Various example embodiments generally relate to the field of wireless communications. Some example embodiments relate to configuration of a multi-SIM (subscriber identity module) device to avoid frequency conflicts between activities associated with different subscriptions.

### BACKGROUND

In various wireless communication systems, for example the 3GPP LTE (Long-Term Evolution) and 5G New Radio (NR), devices may be configured with a dual-mode capability enabling the device to be connected to different network(s), possibly with different radio access technologies (RAT). Additionally, a device may include multiple subscriber identity modules to operate with multiple subscriptions, which may be associated with the same or different network operator. Interoperability of such systems may be however further improved.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. The scope of protection sought for various embodiments of the present disclosure is set out by the independent claims.

Example embodiments of the present disclosure enable to avoid frequency conflicts between operations at different networks, for example in multi-SIM devices having frequency band dependent dual-mode capabilities. This and other benefits may be achieved by the features of the independent claims. Further advantageous implementation forms are provided in the dependent claims, the description, and the drawings.

According to a first aspect, an apparatus may comprise at least one processor and at least one memory including computer program code, the at least one memory and the computer code configured to, with the at least one processor, cause the apparatus at least to: receive, from a first network, a measurement configuration comprising an indication of a plurality of frequencies or cells for performing cell measurements; determine, from the plurality of frequencies or cells, at least one non-preferred frequency or cell at which simultaneous operation of the apparatus at the first network and at least one second network is restricted; and transmit an indication of the at least one non-preferred frequency or cell to the first network.

According to an example embodiment of the first aspect, the apparatus may be associated with the first network with a first subscriber identity and with the at least one second network with at least one second subscriber identity.

According to an example embodiment of the first aspect, the at least one memory and the computer code may be further configured to, with the at least one processor, cause the apparatus to: receive an updated measurement configuration, wherein the updated measurement configuration does not comprise an indication of the at least one non-preferred frequency or cell, or wherein the updated measurement configuration comprises at least one adjusted threshold for triggering at least one measurement report for the at least one non-preferred frequency or cell; perform the cell measurements based on the updated measurement configuration; and transmit, to the first network, the at least one measurement report comprising results of the cell measurements.

According to an example embodiment of the first aspect, the measurement configuration may comprise a first radio resource control reconfiguration, and/or the updated measurement configuration may comprise a second radio resource control reconfiguration.

According to an example embodiment of the first aspect, the indication of the at least one non-preferred frequency or cell may be included in a radio resource control setup complete message, a radio resource control connection setup complete message, or a radio resource control reconfiguration complete message.

According to an example embodiment of the first aspect, the at least one memory and the computer code may be further configured to, with the at least one processor, cause the apparatus to: perform the cell measurements based on the measurement configuration; and transmit, to the first network, at least one measurement report comprising results of the cell measurements and the indication of the at least one non-preferred frequency or cell.

According to an example embodiment of the first aspect, the indication of the at least one non-preferred frequency or cell may comprise a list of frequencies or cells associated with a priority order.

According to an example embodiment of the first aspect, the priority order may be indicated by a sorting order of the list of frequencies or cells.

According to an example embodiment of the first aspect, the at least one memory and the computer code may be further configured to, with the at least one processor, cause the apparatus to: receive, from the first network, an indication to modify the sorting order based on the priority order.

According to an example embodiment of the first aspect, the at least one memory and the computer code may be further configured to, with the at least one processor, cause the apparatus to: modify the sorting order of the list of frequencies or cells based on applying at least one offset value to the at least one non-preferred frequency or cell.

According to an example embodiment of the first aspect, the at least one memory and the computer code may be further configured to, with the at least one processor, cause the apparatus to: receive the at least one offset value from the first network.

According to an example embodiment of the first aspect, the at least one memory and the computer code may be further configured to, with the at least one processor, cause the apparatus to: determine the at least one non-preferred frequency or cell based on at least one frequency for which the apparatus does not support a dual-reception capability with respect to the first network and the second network.

According to a second aspect, a method may comprise: receiving, by a device from a first network, a measurement configuration comprising an indication of a plurality of frequencies or cells for performing cell measurements; determining, from the plurality of frequencies or cells, at least one non-preferred frequency or cell at which simultaneous operation of the device at the first network and at least one second network is restricted; and transmitting an indication of the at least one non-preferred frequency or cell to the first network.

According to an example embodiment of the second, the device may be associated with the first network with a first subscriber identity and with the at least one second network with at least one second subscriber identity.

According to an example embodiment of the second aspect, the method may further comprise: receiving an updated measurement configuration, wherein the updated measurement configuration does not comprise an indication of the at least one non-preferred frequency or cell, or wherein the updated measurement configuration comprises at least one adjusted threshold for triggering at least one measurement report for the at least one non-preferred frequency or cell; performing the cell measurements based on the updated measurement configuration; and transmitting, to the first network, the at least one measurement report comprising results of the cell measurements.

According to an example embodiment of the second aspect, the measurement configuration may comprise a first radio resource control reconfiguration, and/or the updated measurement configuration may comprise a second radio resource control reconfiguration.

According to an example embodiment of the second aspect, the indication of the at least one non-preferred frequency or cell may be included in a radio resource control setup complete message, a radio resource connection control setup complete message, or a radio resource control reconfiguration complete message.

According to an example embodiment of the second aspect, the method may further comprise: performing the cell measurements based on the measurement configuration; and transmitting, to the first network, at least one measurement report comprising results of the cell measurements and the indication of the at least one non-preferred frequency or cell.

According to an example embodiment of the second aspect, the indication of the at least one non-preferred frequency or cell may comprise a list of frequencies or cells associated with a priority order.

According to an example embodiment of the second aspect, the priority order may be indicated by a sorting order of the list of frequencies or cells.

According to an example embodiment of the second aspect, the method may further comprise: receiving, from the first network, an indication to modify the sorting order based on the priority order.

According to an example embodiment of the second aspect, the method may further comprise: applying at least one offset value to the at least one non-preferred frequency or cell to modify the sorting order of the list of frequencies or cells.

According to an example embodiment of the second aspect, the method may further comprise: receiving the at least one offset value from the first network.

According to an example embodiment of the second aspect, the method may further comprise: determining the at least one non-preferred frequency or cell based on at least one frequency for which the device does not support a dual-reception capability with respect to the first network and the second network.

According to a third aspect, a computer program may comprise instructions for causing an apparatus to perform at least the following: receiving, from a first network, a measurement configuration comprising an indication of a plurality of frequencies or cells for performing cell measurements; determining, from the plurality of frequencies or cells, at least one non-preferred frequency or cell at which simultaneous operation of the apparatus at the first network and at least one second network is restricted; and transmitting an indication of the at least one non-preferred frequency or cell to the first network. The computer program may further comprise instructions for causing the apparatus to perform any example embodiment of the method of the second aspect.

According to a fourth aspect, an apparatus may comprise means for receiving, from a first network, a measurement configuration comprising an indication of a plurality of frequencies or cells for performing cell measurements; means for determining, from the plurality of frequencies or cells, at least one non-preferred frequency or cell at which simultaneous operation of the apparatus at the first network and at least one second network is restricted; and means for transmitting an indication of the at least one non-preferred frequency or cell to the first network. The apparatus may further comprise means for performing any example embodiment of the method of the second aspect.

According to a fifth aspect, an apparatus may comprise at least one processor; and at least one memory including computer program code, the at least one memory and the computer code configured to, with the at least one processor, cause the apparatus at least to: transmit, from a first network to a device, a measurement configuration comprising an indication of a plurality of frequencies or cells for performing cell measurements; receive, from the device, an indication of at least one non-preferred frequency or cell at which simultaneous operation of the device at the first network and at least one second network is restricted; and reconfigure the first network to deprioritize use of the at least one non-preferred frequency or cell for the device.

According to an example embodiment of the fifth aspect, the at least one memory and the computer code may be further configured to, with the at least one processor, cause the apparatus to: determine an updated measurement configuration based on removing an indication of the at least one non-preferred frequency or cell from the indication of the plurality of frequencies or cells, or, determine the updated measurement configuration based on adjusting at least one threshold for triggering at least one measurement report for the at least one non-preferred frequency or cell; and transmit the updated measurement configuration to the device.

According to an example embodiment of the fifth aspect, the measurement configuration may comprise a first radio resource control reconfiguration, and/or the updated measurement configuration may comprise a second radio resource control reconfiguration.

According to an example embodiment of the fifth aspect, the indication of the at least one non-preferred frequency or cell may be included in a radio resource control setup complete message, a radio resource control connection setup complete message, or a radio resource control reconfiguration complete message.

According to an example embodiment of the fifth aspect, the at least one memory and the computer code may be further configured to, with the at least one processor, cause the apparatus to: receive, from the device, at least one measurement report comprising results of the cell measurements and the indication of the at least one non-preferred frequency or cell.

According to an example embodiment of the fifth aspect, the indication of the at least one non-preferred frequency or cell may comprise a list of frequencies or cells associated with a priority order determined by the device.

According to an example embodiment of the fifth aspect, the priority order may be indicated by a sorting order of the list of frequencies or cells.

According to an example embodiment of the fifth aspect, the at least one memory and the computer code may be further configured to, with the at least one processor, cause the apparatus to: transmit, to the device, an indication to modify the sorting order based on the priority order.

According to an example embodiment of the fifth aspect, the at least one memory and the computer code may be further configured to, with the at least one processor, cause the apparatus to: transmit, to the device, at least one offset value for modifying the sorting order of the list of frequencies or cells.

According to an example embodiment of the fifth aspect, the at least one memory and the computer code may be further configured to, with the at least one processor, cause the apparatus to: deprioritize the at least one non-preferred frequency or cell when configuring a handover for the device.

According to a sixth aspect, a method may comprise: transmitting, from a first network to a device, a measurement configuration comprising an indication of a plurality of frequencies or cells for performing cell measurements; receiving, from the device, an indication of at least one non-preferred frequency or cell at which simultaneous operation of the device at the first network and at least one second network is restricted; and reconfiguring the first network to deprioritize use of the at least one non-preferred frequency or cell for the device.

According to an example embodiment of the sixth aspect, the method may further comprise: determining an updated measurement configuration based on removing an indication of the at least one non-preferred frequency or cell from the indication of the plurality of frequencies or cells, or, determining the updated measurement configuration based on adjusting at least one threshold for triggering at least one measurement report for the at least one non-preferred frequency or cell; and transmitting the updated measurement configuration to the device.

According to an example embodiment of the sixth aspect, the measurement configuration may comprise a first radio resource control reconfiguration, and/or the updated measurement configuration may comprise a second radio resource control reconfiguration.

According to an example embodiment of the sixth aspect, the indication of the at least one non-preferred frequency or cell may be included in a radio resource control setup complete message, a radio resource control connection setup complete message, or a radio resource control reconfiguration complete message.

According to an example embodiment of the sixth aspect, the method may further comprise: receiving, from the device, at least one measurement report comprising results of the cell measurements and the indication of the at least one non-preferred frequency or cell.

According to an example embodiment of the sixth aspect, the indication of the at least one non-preferred frequency or cell may comprise a list of frequencies or cells associated with a priority order determined by the device.

According to an example embodiment of the sixth aspect, the priority order may be indicated by a sorting order of the list of frequencies or cells.

According to an example embodiment of the sixth aspect, the method may further comprise: transmitting, to the device, an indication to modify the sorting order based on the priority order.

According to an example embodiment of the sixth aspect, the method may further comprise: transmitting, to the device, at least one offset value for modifying the sorting order of the list of frequencies or cells.

According to an example embodiment of the sixth aspect, the method may further comprise: deprioritizing the at least one non-preferred frequency or cell when configuring a handover for the device.

According to a seventh aspect, a computer program may comprise instructions for causing an apparatus to perform at least the following: transmitting, from a first network to a device, a measurement configuration comprising an indication of a plurality of frequencies or cells for performing cell measurements; receiving, from the device, an indication of at least one non-preferred frequency or cell at which simultaneous operation of the device at the first network and at least one second network is restricted; and reconfiguring the first network to deprioritize use of the at least one non-preferred frequency or cell for the device. The computer program may further comprise instructions for causing the apparatus to perform any example embodiment of the method of the sixth aspect.

According to an eighth aspect, an apparatus may comprise means for transmitting, from a first network to a device, a measurement configuration comprising an indication of a plurality of frequencies or cells for performing cell measurements; means for receiving, from the device, an indication of at least one non-preferred frequency or cell at which simultaneous operation of the device at the first network and at least one second network is restricted; and means for reconfiguring the first network to deprioritize use of the at least one non-preferred frequency or cell for the device. The apparatus may further comprise means for performing any example embodiment of the method of the sixth aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication system, according to an example embodiment;

FIG. 2 illustrates an example of an apparatus configured to practice one or more example embodiments;

FIG. 3 illustrates an example of operations and communication between a user equipment (UE) and a network according to an enhanced radio resource control (RRC) configuration procedure, according to an example embodiment;

FIG. 4 illustrates an example of operations and communication between a UE and a network according to an enhanced handover measurement procedure, according to an example embodiment;

FIG. 5 illustrates an example of operations and communication between a UE and a network according to an enhanced handover measurement procedure with a modified sorting order of a measurement report list, according to an example embodiment;

FIG. 6 illustrates an example of a method for configuring non-preferred frequencies or cells at a device, according to an example embodiment; and

FIG. 7 illustrates an example of a method for configuring non-preferred frequencies or cells at a network node, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Example embodiments of the present disclosure enable addressing challenges to support operations with multiple subscriber identity modules (SIM) at a device. A SIM may comprise for example the USIM (universal SIM) of the 3GPP (3rd generation partnership project) LTE or 5G NR standards. Even though some example embodiments have been described using the USIM as an example, it is appreciated that the example embodiments may be applied to any other subscriber identity modules or in general technologies enabling a subscription of a user to be identified. A multi-USIM (MUSIM) device may be equipped with two (dual) or more (multiple) simultaneous network subscriptions (e.g. based on 3GPP or 3GPP2 specifications) with multiple corresponding international mobile subscriber identities (IMSI), e.g. in case of the enhanced packet service (EPS) of 3GPP LTE or subscription permanent identifiers (SUPI), e.g. in case of the 5GS (5G system). Each USIM may be associated with a particular subscription belonging to the same or different network operator, for example a mobile network operator (MNO) or a mobile virtual network operator (MVNO). The maximum number of USIMs supported by a device may be limited, for example to two supported USIMs. However, devices with more than two USIMs may be envisioned, for example with the introduction of electronic SIM (e-SIM).

MUSIM devices which may be registered with two or more independent subscriber IDs (USIMs) and are capable of being in an idle mode (e.g. RRC_IDLE) on all of their USIMs may be referred to as Dual SIM Dual Standby (DSDS) or Multi USIM Multi Standby (MUMS) devices. However, a DSDS or MUMS device may be limited to be in a connected mode (e.g. RRC_CONNECTED) with a single USIM at a given time.

MUSIM devices which may be registered with two or more independent subscriber IDs (USIMs) and are capable of being both in the idle mode and in the connected mode on all USIMs may be referred to as Dual SIM Dual Active (DSDA) or Multi USIM Multi Active (MUMA) devices. DSDA or MUMA devices may therefore maintain for example RRC_CONNECTED mode activities on all USIMs.

The behaviour of a device with respect to simultaneous operation with multiple USIMs may depend on the capabilities of the device related to concurrent independent receiver (RX) and/or transmitter (TX) operations, for example as listed below:

Type 1: Single-RX/Single-TX. The device may be only capable of receiving traffic from one network and/or transmitting traffic to one network at a time.

Type 2: Dual-RX/Single-TX. The device may be capable of simultaneously receiving traffic from two networks but is capable of transmitting to only one network at a time.

Type 3: Dual-RX/Dual-TX. The device may be capable of simultaneously receiving and/or transmitting to/from two networks. Operation of a Type 2 device could be extended to cover simultaneous reception and/or transmission to/from more than two networks.

A dual-RX device may be expected to perform simultaneous RX activities on both of its USIMs, for example to perform reception on one USIM in idle or inactive mode (e.g. RRC_IDLE or RRC_INACTIVE) while maintaining connection (e.g. RRC_CONNECTED) using another USIM, or, to perform independent idle/inactive mode operations concurrently on more than one USIM. However, a dual-RX MUSIM device may still act as a single-RX device for some specific frequency band, frequency, frequency range, bandwidth, or a combination thereof, for example due to one or more of the following non-limiting reasons:
1) Depending on the RF (radio frequency) HW (hardware) design, not all RX and TX chains of the device may cover all configured frequency ranges, for example at the frequency range 1 (FR1) including the low band (LB, 600-850 MHZ), the mid-band (MB, 2.5-3.7 GHZ), the high band (HB, 25-39 GHZ)), and the ultra-high band (UHB), or the frequency range 2 (FR2). Furthermore, support for multiple-input multiple-output (MIMO) communication may not be provided for all frequencies.
2) Depending on the RF HW design, the RF front-end components may be shared for carriers in the same band group, for example LB, MB, HB, or UHB.
3) In-device self-interference cancellation may be applied to cancel generated continuous wave (CW) interference and modulated spurs. However, this may require synchronized knowledge on RX and TX local oscillators and this information may not be available in a MUSIM scenario.

Radio resource control (RRC) may refer to provision of radio resource related control data. Radio resource control messages may be transmitted on various logical control channels such as for example a common control channel (CCCH) or a dedicated control channel (DCCH). Logical control channels may be mapped to one to more signaling radio bearers (SRB). It is however noted that example embodiments may be implemented with any suitable control signals or messages.

As noted above, a device may be in different radio resource control modes or states with respect to different networks and/or with different USIMs. When the device is powered up, the device may be in a disconnected mode or an idle mode (e.g. RCC_IDLE). The device may move to a connected mode (e.g. RRC_CONNECTED) mode for example through connection establishment to a network. The device may however stay for example at the idle mode with respect to another network. If the device is not active for a certain time, the device may move from the connected mode to an inactive mode (e.g. RCC_INACTIVE).

In the idle mode, the device may not be associated with an RRC context. From the network point of view there may not be a connection between the radio access network and the core network for the device. Therefore, the device may not communicate application data with the network. The device may be also in a sleep-mode and only intermittently wake-up to receive paging messages. The device may however perform cell re-selection and other idle mode operations, which may require use of reception and/or transmission resources of the device. In the connected mode, the device may be associated with an RRC context and the device may communicate with the core network elements via the radio access network.

In the inactive state, the device may stay registered to the network and the connection to the radio access network may be suspended. The radio access network may store the UE context, which enables the connection to be quickly resumed. However, the connection to the core network may be maintained.

The device may move to the inactive mode from the connected node. The device may move to the idle mode from the connected or inactive mode. Even though example embodiments have been described using the RCC_IDLE, RCC_INACTIVE, or RCC_CONNECTED modes of the 5G system as examples, it is appreciated the example embodiments may be applied to other type of idle, inactive, or connected mode, for example having similar characteristics as the RCC_IDLE mode, the RCC_INACTIVE mode, or the RCC_CONNECTED mode.

In the connected mode, the device may perform radio resource management (RRM) measurements, for example in relation to a mobility (handover) procedure. The device may report its measurement results to the network, for example periodically and/or in response to detecting a reporting triggering criterion to be fulfilled. The network may configure the device with a measurement configuration, which may include one or more measurement objects (e.g. frequencies) to be measured. The measurement configuration may further include one or more reporting events. The reporting triggering criteria (reporting events) may be for example based on measured absolute reference signal received level values, for example reference signal received power (RSRP), reference signal received quality (RSRQ), and/or signal-to-interference-plus-noise ratio (SINR), of the serving cell of the device. Alternatively, or additionally, the reporting events may be triggered based on relative signal level or quality (e.g. RSRP, RSRQ, SINR) of a neighbouring cell compared to measured value(s) of the serving cell.

For example, one or more of the following measurement events or other events not disclosed herein may be configured:
Event A1: serving cell becomes better than a threshold,
Event A2: serving cell becomes worse than threshold,
Event A3: neighbour cell becomes an offset better than a special (SpCell), for example a primary serving cell of either the master cell group (MCG) or a secondary cell group (SCG),
Event A4: Neighbour cell becomes better than a threshold,
Event A5: SpCell becomes worse than a first threshold and a neighbour cell becomes better than a second threshold,
Event A6: Neighbour cell becomes an offset better than a secondary cell (Scell),
Event B1: an inter-RAT neighbour cell becomes better than threshold),
Event B2: a primary cell (Pcell) becomes worse than a first threshold and inter-RAT neighbour cell becomes better than a second threshold.

A base station, such as for example a 5G base station (gNB), may specify the triggering quantity and reporting quantity in the measurement report configuration. Quantities could be one of the RSRP, RSRQ or SINR.

The device may send measurement reports to the network when at least one triggering criterion is satisfied. A measurement report may include measurement results from the serving cell(s) and neighbour cell(s). An example of a measurement result information element (IE) (MeasResult) is provided below. It is however noted that a measurement report may include one or more of the following information fields or parameters and not necessarily all of them.

MeasResults ::= SEQUENCE {
measId MeasId,
measResultServingMOList MeasResultServMOList,
measResultNeighCells CHOICE {
measResultListNR MeasResultListNR,
measResultListEUTRA MeasResultListEUTRA } OPTIONAL,
...,
}

The measurement result IE may therefore comprise a list of measured results (measResultListNR) for a plurality of cells. The measurement result IE may further comprise an identifier (MeasId) of the reported measurement list.

The measurement result list (MeasResultListNR) field may include a list of measurement results which may include cell specific and reference signal specific measurements. An example of a measurement result IE is provided below. The list of measurement results may include multiple measurement result IEs. It is however noted that a measurement result element may include one or more of the following information fields or parameters and not necessarily all of them.

```
MeasResultListNR ::= SEQUENCE (SIZE(1..maxCellReport)) OF
MeasResultNR
MeasResultNR ::= SEQUENCE {
  physCellId PhysCellId OPTIONAL,
  measResult SEQUENCE {
    cellResults SEQUENCE {
      resultsSSB-Cell MeasQuantityResults OPTIONAL,
      resultsCSI-RS-Cell MeasQuantityResults OPTIONAL
      },
    rsIndexResults SEQUENCE {
      resultsSSB-Indexes ResultsPerSSB-IndexList OPTIONAL,
      resultsCSI-RS-Indexes ResultsPerCSI-RS-IndexList
      OPTIONAL
      } OPTIONAL
    },
...,
}
```

The measurement result IE may therefore comprise an identifier (e.g. PhysCellId) of the measured cell. The measurement result IE may comprise measurement results with respect to one or more measurement quantities.

When more than one measurement result is available, the device may provide the results in a sorted order in the measurement result list within the measurement report. The sorting quantity may be for example the quantity used for the thresholds (for events A1, A2, A4, B1) or offset (for event A3). For A5 and B2, the sorting quantity may be the quantity used in the neighbour threshold (second threshold).

For example, the device may be configured with Event A3 and two measurement objects, e.g. for a first frequency and a second frequency, having the same report configuration with triggering quantity RSRP configured for both measurement objects. When the triggering criterion is satisfied for two cells, e.g. a first cell (Cell 1) and a second cell (Cell 2) having first and second frequencies and measured signal strengths RSRP 1 and RSRP 2, respectively, the device may include in the (neighbour) measurement list information of the first cell ({Cell 1, RSRP1}) followed by information of the second cell ({cell2, RSRP2}) within measurement report. However, if RSRP 2>RSRP 1, information of the second cell ({Cell 2, RSRP 2}) may be included first in the measurement report list. The sorting order of the measurement list may be therefore indicative of a priority order of the reported cells, e.g., for handover purposes. Reporting the measurements in the sorted order enables the network (e.g. a gNB) to select the cell corresponding to the first measurement in the measurement result list and initiate a handover. If the first cell is not suitable or less preferred (for example due to admission control), the network may select the next cell from the list and so on. The sorting order may be modified to avoid frequency conflicts with different networks, as will be further described below. The sorting order is however just one example of indicating a priority order of the measurement results or measured cells to the network and in general the priority order could be indicated by any suitable manner.

Example embodiments of the present disclosure may address operations associated with multi-USIM devices, for example when handling mobile-terminated (MT) services. In particular, some example embodiments may be related to handling the MT services for a multi-USIM device with the target of avoiding unnecessary interruptions of the MT service and to avoid unnecessary use of system resources. Example embodiments may further enable to prevent another network, which triggered a paging message, from performing undesirable operations (e.g. to avoid wasting resources or to avoid wrong assumptions of reachability of the multi-USIM device, or the like). Furthermore, more reliable paging reception in a multi-USIM device may be enabled. Example embodiments may for example enable operation when paging associated with 3GPP radio access technologies and systems in which the multi-USIM device is in idle state or inactive state (e.g. for 5GS) overlap in time. Example embodiments also enable the network to be informed about specific communication constraints of the multi-USIM device (e.g. single-RX capability) to enable the multi-USIM device to receive paging for each of its registered USIMs. Furthermore, coordinated leaving for multi-USIM device may be considered. For example, the example embodiments enable a multi-USIM device to leave the current 3GPP system in coordination with the network such that wasting of network resources is avoided when leaving the system. Furthermore, the example embodiments enable handling the mobile-terminated data or mobile-terminated control-plane activity after the multi-USIM device has left the system, for example when the device is in idle or inactive state in the current system (e.g. EPS or 5GS).

Furthermore, RAN level MUSIM support may be considered. For example, for Single-RX/Single-TX devices, the example embodiments enable avoiding collisions due to reception of paging when the device is in the idle or inactive mode with respect to different networks associated with respective USIMs. For Single-RX/Single-TX devices and Dual-RX/Single-TX devices, enhancements enabling the device to notify the network about its switch from a first network to a second network may be provided. Furthermore, an incoming paging message may be configured to indicate whether the corresponding service is associated with the first network or the second network (e.g. voice-over-LTE or voice-over-NR). The benefits of the various example embodiments will be further discussed below.

As explained above, a device with more than one RX and TX chain may be able to act as a dual-RX device for certain combination of frequency bands, e.g. be capable of simultaneously receiving traffic from two networks on those frequency band(s), while it may act as single-RX for other combinations of frequency bands, e.g. be only capable of receiving traffic from one network on those frequency band(s). Acting as single-RX device for all frequency combinations may not be efficient, since this could cause the device not to make use of its maximum capabilities. The device could be therefore configured to act as dual-RX whenever possible and single-RX when not, for example depending on the frequency band in question. This enables to alleviate the problem to some extent. However, this may not provide optimal efficiency, since the device may have degraded performance on both USIMs when acting as single-RX. Therefore, example embodiments of the present disclosure enable further optimization to increase the likelihood that the MUSIM UEs is able to act as a dual-RX device and thereby to improve the performance of MUSIM devices.

According to an example embodiment, an apparatus may receive, from a first network, a measurement configuration comprising an indication of a plurality of frequencies or cells for performing cell measurements. The apparatus may determine, from the plurality of frequencies or cells, at least one non-preferred frequency or cell at which simultaneous operation of the apparatus at the first network and at least one second network is restricted, and transmit, to the first network, an indication of the at least one non-preferred frequency or cell. The first network may be reconfigured to deprioritize use of the at least one non-preferred frequency or cell for the apparatus. Hence, frequency conflicts between the first and second networks may be avoided, or at least their likelihood may be reduced.

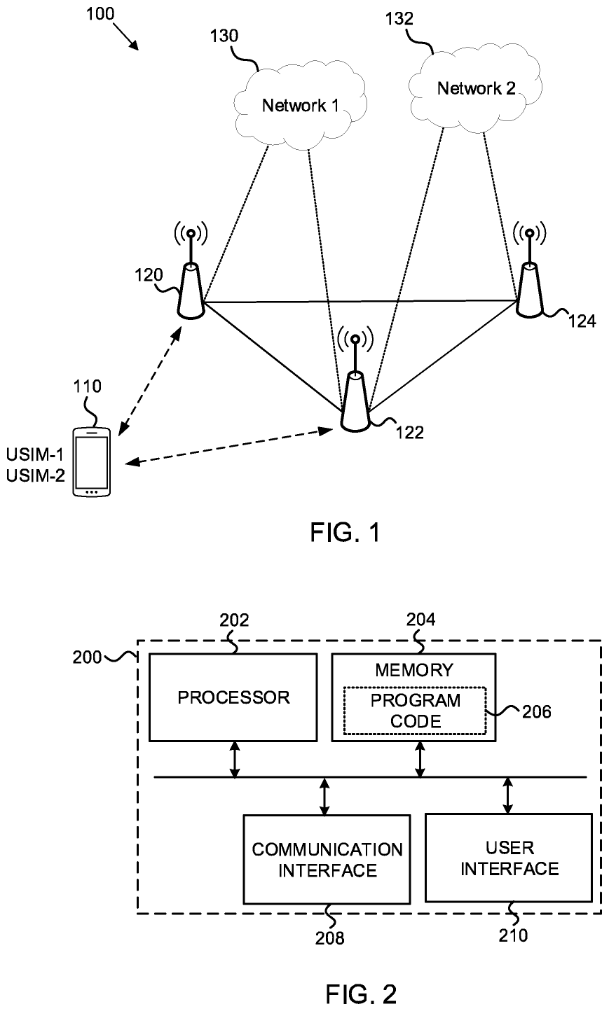

FIG. 1 illustrates an example of a communication system, according to an example embodiment. The communication system 100 may comprise one or more (core) networks 130, 132. The networks 130, 132 may be operated by the same operator or different operators, for example MNO(s) or MVNO(s). The networks 130, 132 may provide network access via at least one radio access network. A radio access network may comprise one or more base stations 120, 122, 124, for example LTE base stations (eNB) or 5G base stations (gNB). The networks 130, 132 may at least partially utilize the same radio access network by sharing at least one of the base stations, e.g. base station 122, for example by means of network slicing, or, they may provide network access via separate radio access networks. The radio access network(s) could be therefore also considered to be part of the networks 130, 132. The networks 130, 132 may comprise core network elements such as for example one or more access and mobility management functions (AMF) and/or one or more user Plane functions (UPF). The communication system 100 may further comprise one or more devices, which may be also referred to as a user nodes or user equipment (UE). The UE 110 may be configured for dual-mode operation with respect to at least one of the networks 130, 132. The UE 110 may comprise a plurality of SIMs, for example USIM-1 and USIM-2. The plurality of SIMs may correspond to different subscriptions to the network 130 and/or the network 132. Communications between the UE 110 and the base stations 120, 122, 124 may be bidirectional. Hence, any of these devices may be configured to operate as a transmitter and/or a receiver.

The base stations 120, 122, 124 may be configured to communicate with the core network elements over a communication interface, such as for example a control plane interface or a user plane interface NG-C/U. Base stations 120, 122, 124 may be also called radio access network (RAN) nodes and they may be part of the radio access network between the networks 130, 132 and the UE 110. Functionality of a base station may be distributed between a central unit (CU), for example a gNB-CU, and one or more distributed units (DU), for example gNB-DUs. The base stations 120, 122, 124, or core network elements such as AMF or UPF may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

In a split architecture scenario, central unit of a base station may comprise a physical or logical node and may include functions such as for example transfer of user data, mobility control, radio access network sharing, positioning, session management, or the like, except for functions that may be allocated to the distributed unit(s). The central unit may be connected to the one or more distributed units over a communication interface, for example an F1 interface.

The one or more distributed units may be physical or logical nodes that may be configured to provide a subset of base station functions, depending on how the functions are split between the central unit and the distributed unit(s). The distributed unit(s) may be controlled by the central unit through the communication interface. A base station may be connected to other radio access network nodes by another communication interface, for example an Xn interface. It is appreciated that network functionality described herein may be implemented at a gNB, or divided between a gNB-CU and a gNB-DU, or corresponding entities of other standards.

The communication system 100 may be configured for example in accordance with 3GPP specifications. In one example, the communication system 100 may operate according to 3GPP 5G-NR (5G New Radio) and/or 3GPP LTE. For example, the network 130 may comprise an LTE network and the network 132 may comprise a 5G network and they may be accessed via corresponding base stations. The networks 130, 132 may be therefore of different types, for example operating according to different standards, or profiles thereof. It is however possible that the networks 130, 132 are of the same type, for example two 5G networks. Even though LTE and 5G have been used as examples, it is appreciated that example embodiments presented herein are not limited to either of these example networks and they may be generally applied in any present or future wireless or wired communication networks, or combinations thereof, for example other type of cellular networks, short-range wireless networks, broadcast or multicast networks, or the like.

FIG. 2 illustrates an example embodiment of an apparatus 200, for example a device such as UE 110, any of the base stations 120, 122, 124, or any network device within the networks 130, 132. The apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special-purpose computer chip, or the like.

The apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 208 configured to enable apparatus 200 to transmit and/or receive information to/from other devices. In one example, apparatus 200 may use communication interface 208 to transmit and/or receive signals, for example PRSs. The communication interface may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

The apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When the apparatus 200 is configured to implement some functionality, some component and/or components of the apparatus 200, such as for example the at least one processor 202 and/or the at least one memory 204, may be configured to implement this functionality.

Furthermore, when the at least one processor 202 is configured to implement some functionality, this functionality may be implemented using the program code 206 comprised, for example, in the at least one memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 200 comprises means for performing at least one example embodiment described herein. In one example, the means comprises the at least one processor 202, the at least one memory 204 including program code 206 configured to, when executed by the at least one processor, cause the apparatus 200 to perform the example embodiment(s).

The apparatus 200 may comprise for example a computing device such as for example a base station, a server, a positioning server, a network device, a mobile phone, a tablet computer, a laptop, an internet of things (IOT) device, or the like. Examples of IoT devices include, but are not limited to, consumer electronics, wearables, sensors, and smart home appliances. In one example, the apparatus 200 may comprise a vehicle such as for example a car. Although apparatus 200 is illustrated as a single device it is appreciated that, wherever applicable, functions of the apparatus 200 may be distributed to a plurality of devices, for example to implement example embodiments as a cloud computing service.

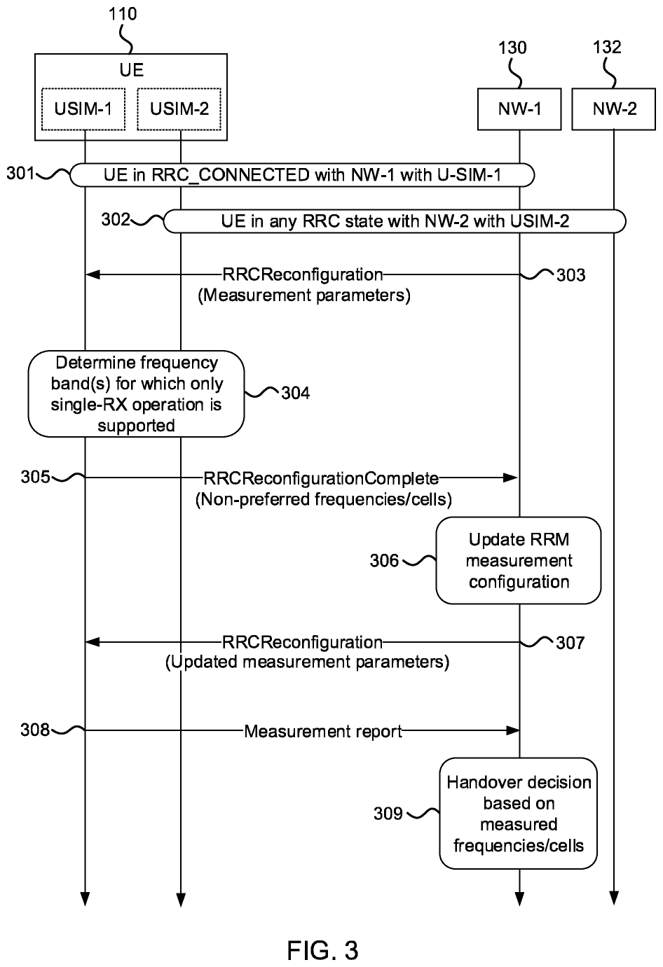

FIG. 3 illustrates an example of operations and communication between a user equipment (UE) and a network according to an enhanced radio resource control (RRC) configuration procedure, according to an example embodiment. Example embodiment(s) of FIG. 3 enable the UE 110 to statically inform the network about which frequency band operations (measurements) would require a gap in RRC connectivity. As will be further described with reference to the various operations, the UE 110 may add a ‘warning flag’ in any suitable RRC message or as assistance information in a new RRC message related to MUSIM switching message to inform that the UE 110 needs a gap for measurements on certain frequency bands. The network may then update the measurement configuration to down-prioritize the problematic bands, if possible. If the RRC configuration is received to operate the UE 110 at a frequency which requires a gap for MUSIM operation, the UE 110 may also indicate the preferred frequency bands in RRC message acknowledgement (e.g. RRC connection setup complete message of LTE, RRC setup complete message of NR, or RRC reconfiguration complete message) to enable reconfiguration or redirection to a frequency which does not require gaps, or, to allow the network to configure the UE 110 to use the gaps.

At operation 301, the UE 110 may establish a connection to the first network 130. The connection may be established using a first SIM (USIM-1). After connection establishment, the UE 110 may be in an RRC_CONNECTED state with respect to the first network 130. The UE 110 may be a DualRX/SingleTX or a DualRX/DualTX MUSIM device.

At operation 302, the UE 110 may be in any RRC state with respect to the second network 132, for example in an RRC_IDLE state, RRC_INACTIVE state, or an RRC_CONNECTED state. The UE 110 may be configured to use a second SIM (USIM-2) for communicating with the second network 132. Note that a DSDA device may be in RRC_CONNECTED state with both USIMs and therefore be able to maintain parallel RX and TX activity across its USIMs. However, a DSDS device may be limited to be in the RRC_CONNECTED state with a single USIM at a given time. Even though some embodiments have been described using USIMs as an example, any suitable method for identifying a user at a network may be applied. In general, the UE 110 may be associated with different networks with different subscriber identities, for example by means of different SIMs For example, the UE 110 may be associated with the first network 130 with a first subscriber identity and with the second network 132 with a second subscriber identity.

At operation 303, the first network 130 may transmit a measurement configuration to the UE 110, for example as an RRC reconfiguration (e.g. RRCReconfiguration message). The measurement configuration may comprise an indication of measurement parameters, for example frequencies or cells for which cell measurements are configured. By means of the measurement configuration, the UE 110 may be configured for RRM measurements of its serving cell as well as a list of neighbouring cells. The measurement parameters may comprise a list of frequencies to be measured, for example included in a measurement object (e.g. MeasObjectNR).

At operation 304, the UE 110 may determine frequency bands, or in general frequencies, for which only single-RX operation is supported. The UE 110 may for example determine the frequency bands configured for neighbouring cell measurements for which it should act as single-RX based on its serving cell frequency at the second network 132. The conflicting frequency bands may be determined based on frequencies configured for use at the serving cell of the second network 132, for example based on a frequency band information field (e.g. FrequencyBandList) received in RRC_IDLE or RRC_INACTIVE modes. The configured frequencies may be used for example for cell (re)selection at the second network 132. The UE 110 may therefore determine, from the frequencies or cells indicated at operation 303, non-preferred frequencies or cells at which simultaneous operation at the first network 130 and the second network 132 is restricted. For example, the UE 110 may not be able to operate simultaneously with both networks, e.g. due to a single-RX capability at the relevant frequencies. Determination of the non-preferred frequencies may be therefore based on frequencies or frequency bands for which the UE 110 does not support a dual-reception capability with respect to the two networks. Alternatively, the UE 110 may have restricted operation capability at the relevant frequencies with respect to the two networks. Such frequencies may be included in the non-preferred frequencies. Even though the non-preferred frequencies or cells have been described in plural, it is appreciated that the UE 110 could also determine and indicate to the first network 130 a single non-preferred frequency or cell.

At operation 305, the UE 110 may transmit an indication of the non-preferred frequencies or cells to the first network 130 for example in an RRC reconfiguration complete message (e.g. RRCReconfigurationComplete). Alternatively, the indication could be provided in a connection setup message, e.g. an RRC (connection) setup complete message (e.g. RRCSetupComplete or RRCConnectionSetupComplete), upon establishment of the connection to the first network 130. The indication may be provided for example based on adding a ‘warning flag’ to the frequencies identified as non-preferred, e.g. frequency bands that would require gaps for activities of the UE 110 in RRC_IDLE or RRC_INACTIVE state with respect to the second network 132. This information may be alternatively transmitted to the first network 130 as UE assistance information in any suitable RRC message, for example the UJEAssistance Information message.

At operation 306, the first network 130 may update the RRM measurement configuration using the information provided by the UE 110 at operation 305. The update may include removing the non-preferred frequencies or cells from the measurements configured at operation 303. Alternatively, reporting threshold(s) corresponding to the non-preferred frequencies or cells may be adjusted to promote or demote specific target cells. For example, the first network 130 could configure a higher RSRP threshold for triggering a measurement report for a particular frequency or cell. This enables to improve performance of the communication system 100, since even measuring such neighbouring cells could potentially collide with activities ongoing with another USIM (e.g. USIM-2) of the UE 110 and therefore a gap in RRC connectivity to the first network 130 could be required if the other USIM is also in RRC_CONNECTED mode with respect to the second network 132 (DSDA case). In general, the first network 130 may be reconfigured to deprioritize use of the non-preferred frequency(ies) or cell(s) for the UE 110. Updating the measurement configuration is therefore an example of reconfiguration of the first network to deprioritize use of the non-preferred frequencies or cells for the UE 110.

At operation 307, the first network 130 may transmit the updated measurement configuration to the UE 110, for example as another RRC reconfiguration. The UE 110 may receive the updated measurement configuration. The updated measurement configuration may not indicate the (removed) non-preferred frequencies or cells. Hence, measurements conflicting with frequencies for which dual-RX capability is not supported by the UE 110 may be avoided. Alternatively, the updated measurement configuration may comprise adjusted threshold(s) for triggering a measurement report for the non-preferred frequencies or cells. Removing the non-preferred frequencies or cells enables to reduce the number of measurements at the conflicting frequencies and thereby the likelihood of a frequency conflict between operations at the first network 130 and the second network 132 is reduced.

At operation 308, the UE 110 may perform cell measurements based on the updated measurement configuration. The UE 110 may also transmit a measurement report comprising measurement results for the frequencies or cells indicated in the updated measurement configuration.

At operation 309, the first network 130 may make a handover decision, for example select a target cell, based on the measurement report received at operation 308. Since the measurement report is based on the updated measurement configuration and hence does not include measurement results for the non-preferred frequencies or cells, or the results associated with those frequencies or cells are deprioritized, the first network 130 may avoid selecting target cells that would cause a frequency conflict between the two networks.

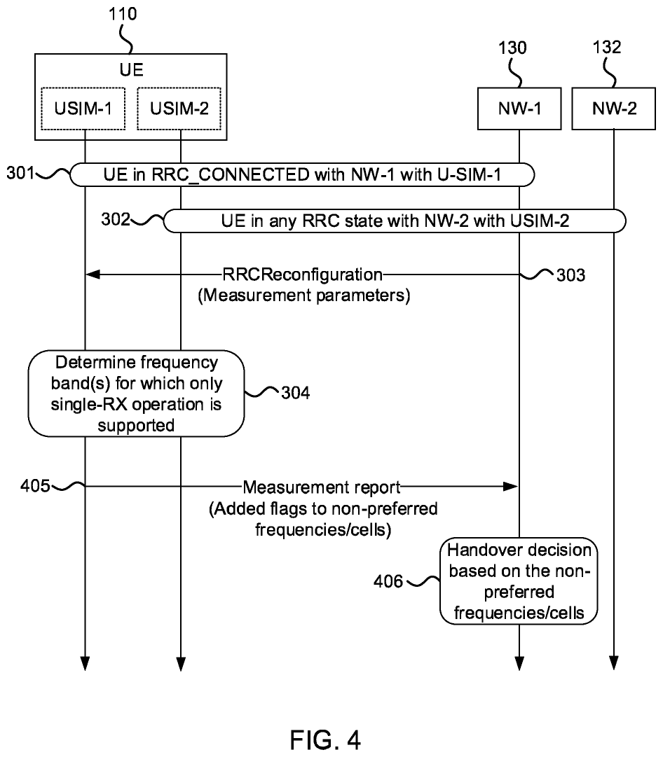

FIG. 4 illustrates an example of operations and communication between a UE and a network according to an enhanced handover measurement procedure, according to an example embodiment. Example embodiment(s) of FIG. 4 enable the UE 110, being in the RRC_CONNECTED state, to provide RRM measurement reports on its serving cell as well as a set of neighbouring cells according to the measurement configuration received from the first network 130 and ‘flag’ measurements associated with preferred neighbour cells where the connection may be maintained without gaps and/or measurements associated with non-preferred neighbour cells where the connection can not be maintained without gaps. The first network 130 may then down-prioritize the non-preferred frequencies, frequency bands, or cells in its handover decision, if possible. The procedure of FIG. 4 may include one or more of the operations 301, 302, 303, and 304 already discussed with reference to FIG. 3.

At operation 405, the UE 110 may transmit a measurement report to the first network 130. The measurement report may be transmitted in response to detecting at least one event triggering the measurement report, for example any of Events A1 to A6, B1 or B2. The measurement report may comprise results of cell measurements indicated in the measurement configuration received by the UE 110 at operation 303. The measurement report may comprise an indication of the non-preferred frequencies or cells determined by the UE 110 at operation 304. The UE 110 may provide the indication of the non-preferred frequencies or cells for example by adding a ‘flag’ to the non-preferred frequencies or cells to the measurement report generated by the UE 110, for example along with the corresponding measured value.

At operation 406, the first network 130 may consider the non-preferred frequencies or cells when making a handover decision. For example, the first network 130 may use this information and deprioritize neighbouring cells associated with the non-preferred frequencies in its decision to prepare a target cell for handover. The first network 130 may for example exclude cells associated with the non-preferred frequencies from a list of candidate target cells for handover for the UE 110. This enables to avoid the UE 110 being handed over to a cell of the first network 130 that is associated with a frequency conflicting with operations at the second network 132. This reduces the likelihood of frequency conflict between operations at the first network 130 and the second network 132.

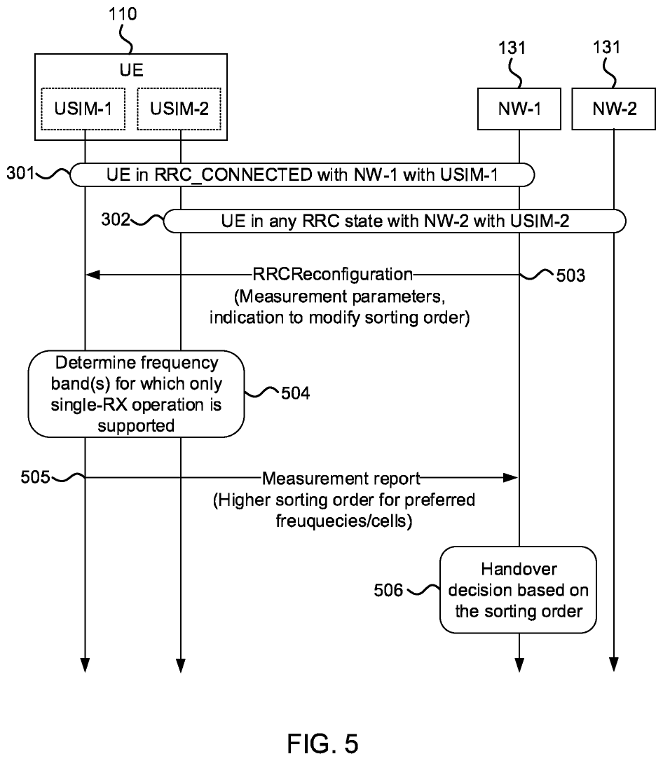

FIG. 5 illustrates an example of operations and communication between a UE and a network according to an enhanced handover measurement procedure with a modified sorting order of measurement report list, according to an example embodiment. Example embodiment(s) of FIG. 5 enable the first network 130 to allow the UE 110 to change the sorting quantity of cell measurement results. The sorting quantity may be a quantity, which is used to determine the sorting order of measurements (cells) in the measurement report. For example, the best cell with respect to the sorting quantity may be included first in the measurement report. Therefore, the UE 110 may place the measurements from cells where it can operate as dual-RX on top of the list as best measurement results. This may be accomplished by direct sorting (e.g. dual-RX enabled frequencies/cells first) or via an offset applied to either the single-RX or dual-RX cases. The measurement results may be therefore biased, for example based on a network-indicated offset. Alternatively, the UE 110 may indicate, for example for each measurement report, whether it can operate according to a dual-RX or single-RX designation for that carrier (frequency). This information may be part of the measurement report and thus it may change dynamically. The procedure of FIG. 5 may include operations 301 and/or 302 already discussed with reference to FIG. 3.

At operation 503, the first network 130 may transmit a measurement configuration to the UE 110, for example as an RRC reconfiguration (e.g. RR(Reconfiguration message). The measurement configuration may comprise an indication of measurement parameters, similar to operation 303. The measurement configuration may further comprise an indication, for example a permission or a request, to modify the sorting order of the measured frequencies or cells in the measurement report list, for example based on a priority order of the frequencies or cells determined by the UE 110. Alternatively, the indication to modify the sorting order may be provided separate from the measurement configuration, for example in another control message such as an RRC message.

For example, as part of the RRCReconfiguration message carrying the measurement configuration, the first network 130 may include a sorting quantity value indicative of permitting or requesting sorting considering the non-preferred frequencies or cells of the UE 110. The new sorting quantity value may be addressed to MUSIM devices. A default sorting operation may be based on RSRP and/or RSRQ as sorting quantities, The default sorting quantity value may be indicated in a control message by the first network 130 to the UE 110, for example in a reportQuantities signaling field.

At operation 504, the UE 110 may determine frequency bands or frequencies, for which only single-RX operation is supported, for example as described with reference to operation 304. The UE 110 may further determine a priority order of the non-preferred frequencies or cells. Preferred frequencies or cells may be ranked higher in the priority order. Non-preferred frequencies or cells may be ranked lower in the priority order. The sorting order of the measurement list may be however different from the priority order. The sorting order may be modified by the UE 110, for example in response to receiving the corresponding indication from the first network 130. The new sorting quantity value provided by the first network 130 may allow the UE 110 to use a sorting based on its preferred frequency bands, e.g. the frequency bands for which the UE 110 is able to use its dual-RX/(dualTX) capability. The sorting order may be therefore indicative of the priority order. The sorting may be for example a combination of existing values together with the (non)-preferred frequency bands.

According to an example embodiment, the UE 110 may apply offset value(s) for modifying the sorting order. For example, offset value(s) may be added to the sorting quantity for measurement(s) associated with non-preferred frequencies or cells. Applying the offset value may cause the non-preferred frequencies or cells to be moved downwards in the sorting order, or in general the sorting order may be modified such that a priority level of the corresponding measurements is lowered. An offset value may indicate a particular movement in the sorting order, for example to shift the corresponding measurement a certain number (indicated by the offset value) of positions in the sorting order. Alternatively, the offset value may be applied to the sorting quantity of the measurement result, for example RSRP, which may cause the sorting order to be modified. The offset value(s) may be received by the UE 110 from the first network 130.

At operation 505, the UE 110 may transmit an indication of the non-preferred frequencies or cells to the first network 130, for example in a measurement report, as described with reference to operation 405. The indication of the non-preferred frequencies or cells may be however provided as the sorted list of frequencies or cells. A higher sorting order within the list may be assigned to preferred frequencies or cells. A lower sorting order may be assigned to non-preferred frequencies or cells.

At operation 506, the first network 130 may perform a handover decision based on the sorting order indicated by the UE 110. Even though the non-preferred frequencies or cells may be indicated in a different way (i.e. by the sorted list), the handover operations may be similar to operation 406. It is however noted that handover is an example of an operation that could benefit from the indication of the non-preferred frequencies or cells. In general, the first network 130 may reconfigure its operation to deprioritize (e.g. avoid or prevent) using the non-preferred frequencies or cells.

Example embodiments of the present disclosure thus enable frequency conflicts between two networks to be avoided or their likelihood to be reduced. Based on the above example embodiments, the first network 130 may prioritize handover preparation of preferred cells, e.g. flagged as preferred, when possible and/or avoid non-preferred cells, e.g. those associated with warning flag. In case of the modified sorting order, the preferred cells may be automatically prioritized at the first network 130 when selecting the target cell. Consequently, this will prevent or reduce the likelihood of the UE 110 being handed over to a serving cell on a frequency which will require interruption in RRC connection to enable the UE 110 to perform its idle or inactive mode operations with respect to the second network 132 in DSDS cases and performing simultaneous connected mode activities at both networks 130, 132 in DSDA cases.

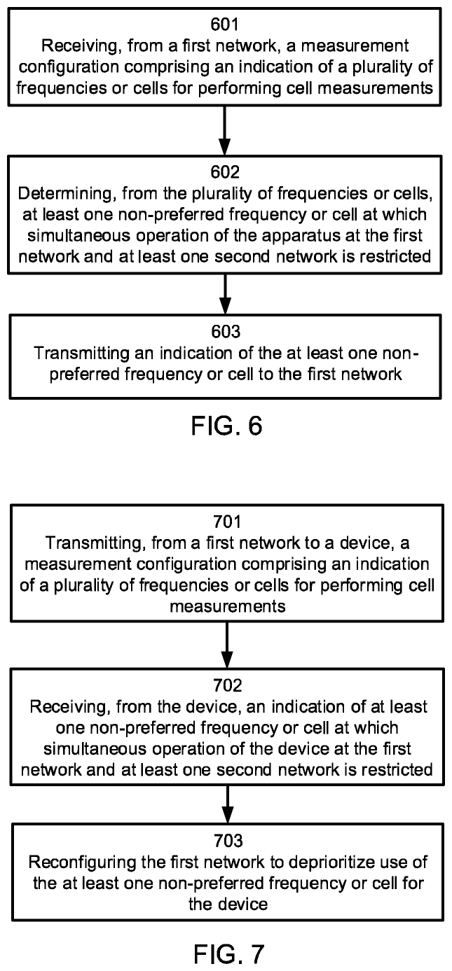

FIG. 6 illustrates an example of a method for configuring non-preferred frequencies or cells at a device, according to an example embodiment.

At 601, the method may comprise receiving, from a first network, a measurement configuration comprising an indication of a plurality of frequencies or cells for performing cell measurements.

At 602, the method may comprise determining, from the plurality of frequencies or cells, at least one non-preferred frequency or cell at which simultaneous operation of the apparatus at the first network and at least one second network is restricted.

At 603, the method may comprise transmitting an indication of the at least one non-preferred frequency or cell to the first network.

FIG. 7 illustrates an example of a method for configuring non-preferred frequencies or cells at a network node, according to an example embodiment.

At 701, the method may comprise transmitting, from a first network to a device, a measurement configuration comprising an indication of a plurality of frequencies or cells for performing cell measurements.

At 702, the method may comprise receiving, from the device, an indication of at least one non-preferred frequency or cell at which simultaneous operation of the device at the first network and at least one second network is restricted.

At 703, the method may comprise reconfiguring the first network to deprioritize use of the at least one non-preferred frequency or cell for the device.

Further features of the methods directly result for example from the functionalities and parameters of the UE 110, the base stations 120, 122, or 124, or the networks 130 or 132, as described in the appended claims and throughout the specification, and are therefore not repeated here. Different variations of the methods may be also applied, as described in connection with the various example embodiments.

An apparatus, for example the UE 110 or a network device, may be configured to perform or cause performance of any aspect of the methods described herein. Further, a computer program may comprise instructions for causing, when executed, an apparatus to perform any aspect of the methods described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable):(i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device. It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code, the at least one memory and the computer code configured to, with the at least one processor, cause the apparatus at least to:
receive, from a first network, a measurement configuration comprising an indication of a plurality of frequencies or cells for performing cell measurements:
determine, from the plurality of frequencies or cells, at least one non-preferred frequency or cell at which simultaneous operation of the apparatus at the first network and at least one second network is restricted; and
transmit an indication of the at least one non-preferred frequency or cell to the first network.

2. The apparatus according to claim 1, wherein the apparatus is associated with the first network with a first subscriber identity and with the at least one second network with at least one second subscriber identity.

3. The apparatus according to claim 1, wherein the at least one memory and the computer code are further configured to, with the at least one processor, cause the apparatus to:
receive an updated measurement configuration, wherein the updated measurement configuration does not comprise an indication of the at least one non-preferred frequency or cell, or wherein the updated measurement configuration comprises at least one adjusted threshold for triggering at least one measurement report for the at least one non-preferred frequency or cell:
perform the cell measurements based on the updated measurement configuration; and
transmit, to the first network, the at least one measurement report comprising results of the cell measurements.

4. The apparatus according to claim 1, wherein the measurement configuration comprises a first radio resource control reconfiguration, and/or wherein the updated measurement configuration comprises a second radio resource control reconfiguration.

5. The apparatus according to claim 1, wherein the indication of the at least one non-preferred frequency or cell is included in a radio resource control setup complete message, a radio resource control connection setup complete message, or a radio resource control reconfiguration complete message.

6. The apparatus according to claim 1, wherein the at least one memory and the computer code are further configured to, with the at least one processor, cause the apparatus to:
perform the cell measurements based on the measurement configuration; and
transmit, to the first network, at least one measurement report comprising results of the cell measurements and the indication of the at least one non-preferred frequency or cell.

7. The apparatus according to claim 1, wherein the indication of the at least one non-preferred frequency or cell comprises a list of frequencies or cells associated with a priority order.

8. The apparatus according to claim 7, wherein the priority order is indicated by a sorting order of the list of frequencies or cells.

9. The apparatus according to claim 1, wherein the at least one memory and the computer code are further configured to, with the at least one processor, cause the apparatus to:
receive, from the first network, an indication to modify the sorting order based on the priority order.

10. The apparatus according to claim 8, wherein the at least one memory and the computer code are further configured to, with the at least one processor, cause the apparatus to:
modify the sorting order of the list of frequencies or cells based on applying at least one offset value to the at least one non-preferred frequency or cell.

11. The apparatus according to claim 10, wherein the at least one memory and the computer code are further configured to, with the at least one processor, cause the apparatus to:
receive the at least one offset value from the first network.

12. The apparatus according to claim 1, wherein the at least one memory and the computer code are further configured to, with the at least one processor, cause the apparatus to:
determine the at least one non-preferred frequency or cell based on at least one frequency for which the apparatus does not support a dual-reception capability with respect to the first network and the second network.

13. An apparatus, comprising:
at least one processor; and
at least one memory including computer program code, the at least one memory and the computer code configured to, with the at least one processor, cause the apparatus at least to:
transmit, from a first network to a device, a measurement configuration comprising an indication of a plurality of frequencies or cells for performing cell measurements:
receive, from the device, an indication of at least one non-preferred frequency or cell at which simultaneous operation of the device at the first network and at least one second network is restricted; and reconfigure the first network to deprioritize use of the at least one non-preferred frequency or cell for the device.

14. The apparatus according to claim 13, wherein the at least one memory and the computer code are further configured to, with the at least one processor, cause the apparatus to:
determine an updated measurement configuration based on removing an indication of the at least one non-preferred frequency or cell from the indication of the plurality of frequencies or cells, or, determine the updated measurement configuration based on adjusting at least one threshold for triggering at least one measurement report for the at least one non-preferred frequency or cell; and
transmit the updated measurement configuration to the device.

15. The apparatus according to claim 13, wherein the measurement configuration comprises a first radio resource control reconfiguration, and/or wherein the updated measurement configuration comprises a second radio resource control reconfiguration.

16. The apparatus according to claim 13, wherein the indication of the at least one non-preferred frequency or cell is included in a radio resource control setup complete message, a radio resource control connection setup complete message, or a radio resource control reconfiguration complete message.

17. The apparatus according to claim 13, wherein the at least one memory and the computer code are further configured to, with the at least one processor, cause the apparatus to:
receive, from the device, at least one measurement report comprising results of the cell measurements and the indication of the at least one non-preferred frequency or cell.

18. The apparatus according to claim 13, wherein the indication of the at least one non-preferred frequency or cell comprises a list of frequencies or cells associated with a priority order determined by the device.

19-21. (canceled)

22. The apparatus according to claim 13, wherein the at least one memory and the computer code are further configured to, with the at least one processor, cause the apparatus to:
deprioritize the at least one non-preferred frequency or cell when configuring a handover for the device.

23. A method, comprising:
receiving, by a device from a first network, a measurement configuration comprising an indication of a plurality of frequencies or cells for performing cell measurements;
determining, from the plurality of frequencies or cells, at least one non-preferred frequency or cell at which simultaneous operation of the device at the first network and at least one second network is restricted; and
transmitting an indication of the at least one non-preferred frequency or cell to the first network.

24-28. (canceled)
